(19) United States
(12) Patent Application Publication
(10) Pub. No.: US 2008/0161994 A1
(43) Pub. Date: Jul. 3, 2008

(54) METHOD AND SYSTEM FOR AUTOGENERATING STATIC FAULT CODE DATA BASED ON A UNIFIED SUMMARY TABLE FOR HEAVY DUTY DIESEL ENGINES

(75) Inventors: Frank S. Groer, Stuttgart (DE); Tomislav I. Golub, Birmingham, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Detroit Diesel Corporation, Detroit, MI (US)

(21) Appl. No.: 11/939,690

(22) Filed: Nov. 14, 2007

Related U.S. Application Data
(60) Provisional application No. 60/877,467, filed on Dec. 28, 2006.

(51) Int. Cl. G01M 17/007; G06F 19/00

(52) U.S. Cl. 701/33

(57) ABSTRACT

A method to autogenerate static fault code data in humanly readable form based upon a Unified Summary Table for Heavy Duty Diesel Engines is disclosed.

### CROSS-REFERENCE TO RELATED APPLICATIONS

The present application claims priority to U.S. Provisional Application Ser. No. 60/887,467 filed on Dec. 28, 2006, the contents of which are incorporated herein in their entirety.

### BACKGROUND OF THE INVENTION

1. Field of the Invention

Recently, there is a trend to increase the memory and processing to control a heavy duty diesel engine. This has resulted in changes in architecture in the control of heavy duty diesel engines, wherein the electronic control is divided between a Motor Control Module and a Common Powertrain Controller. Ordinarily the Motor Control Module includes the operating software instructions for the engine and its components, and the Common Powertrain Controller acts to communicate those instructions to the engine components thus providing for increase memory capabilities of the MCM. In addition the CPC can receive data signals and other input from the components and make operating decisions.

The present invention is directed to a single course database which contains all static and fault control data with any required faults description in a single file for a heavy duty diesel engine. The file is stored as a table, preferably within the memory of a Motor Control Module (MCM). Preferably, the table is stored as an excel spreadsheet format and is humanly readable when accessed by any service tool. An automated tool infrastructure is then built around the excel source file which parses and interprets the data providing several parallel output paths. The tool distills all required information to be complied with the main controller software build and a different set of linked data is provided to the service tools which are then able to display a detailed textual description about any individual system fault.

2. Description of the Related Art

Pajakowski et al., U.S. Pat. No. 7,191,040 discloses a handheld computer based system for collecting display and analysis of engine or vehicle data. The handheld computer may be a Palm Pilot and is compatible with Windows programs. The handheld unit includes an adapter for creating a data pathway between a vehicle bus connector and an external data port on the hand held computer that is physically incompatible with engine bus connector. The adapter includes a data port connector for connection with the external data port, a bus compatible connector for connection with the engine bus connector, a battery power supply separate from the power supply of the handheld unit and an adapter microprocessor powered by the battery supply and connected via the data pathway with the bus compatible for protocol conversion of the data received from the engine bus.

Goodwin, U.S. Pat. No. 7,158,978 discloses a computerized record keeping system and method using a network to keep record that cannot be erased by a user thereby guaranteeing the accuracy of the records kept with the system. A client computer contacts the system through a computer network, a server system which stores a client database accessible by a password. The client system can review, search, and add records to the database. The client database on the server system is automatically backed-up to avoid inadvertent loss of records or data. Once a record is entered into the server system through the client system, it is permanently stored in the server system as a part of the client database. While a client system may enter a modified record, the original record is always maintained and displayed with the now modified record.

Pajakowski et al., U.S. Pat. No. 6,718,425 discloses a handheld computer based system for collecting display and analysis of engine or vehicle data. The handheld computer may be a Palm Pilot and is compatible with Windows programs. The handheld unit includes an adapter for creating a data pathway between a vehicle bus connector and an external data port on the hand held computer that is physically incompatible with engine bus connector. The adapter includes a data port connector for connection with the external data port, a bus compatible connector for connection with the engine bus connector, a battery power supply separate from the power supply of the handheld unit and an adapter microprocessor powered by the battery supply and connected via the data pathway with the bus compatible for protocol conversion of the data received from the engine bus.

Nguyen et al., U.S. Pat. No. 6,003,808 discloses a system to provide engine maintenance information automatically from fault code data received from an onboard engine performance monitoring computer. The maintenance information is provided by and HTML repair guide electronically called by the control system using the fault code as a part of the page address in the HTML guide. The control system automatically ensures that all fault codes are responded to by the maintenance personnel with a view to improve quality assurance of the maintenance.

### BRIEF SUMMARY OF THE INVENTION

The present invention relates to a method for autogenerating static fault codes based upon a unified summary table for an electronic control heavy duty diesel engine. The method comprises compiling vehicle fault codes in a table within the memory in a humanly readable format, communicating the fault codes to a service tool for diagnosis or service. The method further includes storing the fault codes in the memory of a Motor Control Module and communicating the fault codes to a Component Processor Controller for access by a service tool Preferably, the fault codes are stored in a table in memory in an excel (xls.) format. These and other objects and details will become apparent upon a reading of the attached description.

### BRIEF DESCRIPTION OF THE DRAWINGS

FIG. 1 is a schematic representation of the system for autogenerating static fault code data based upon a unified summary table for heavy duty diesel engines.

FIG. 2 is a schematic presentation of the interfaces between controllers in a control module of a heavy duty diesel engine.

### DETAILED DESCRIPTION OF THE INVENTION

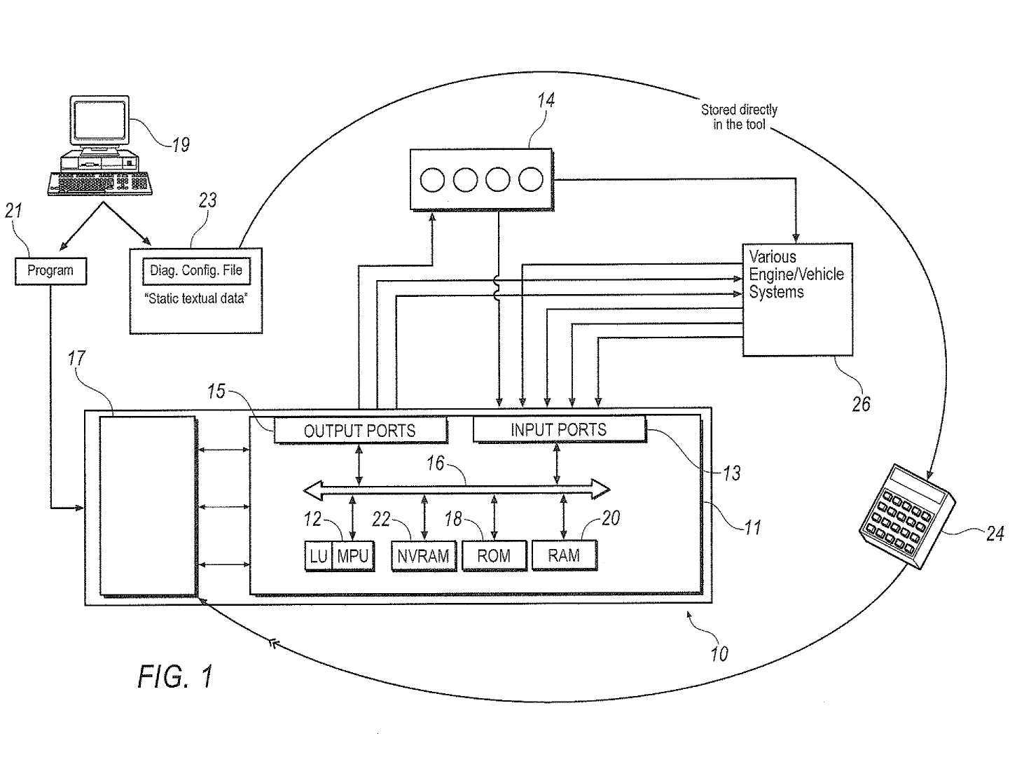

FIG. 1 is a schematic representation of an engine controller 10 such as an electronic control module composed of a Motor Control Module (MCM) 11 and a Common Powertrain Controller (CPC2) 17. The MCM controls various operations of the engine 14 and other system or subsystems associated therewith. Various sensors may be in electrical communication with the controller via input ports 13 and output ports 15. The controller 10 may include a microprocessor unit (MPU) 12 in communication with various computer readable storage media via a data and control bus 16. The computer readable storage media may include any of a number of known devices which function as read only memory 18, random access memory 20, and non-volatile random access memory 22. A data, diagnostics, and programming input and output device 24 may also be selectively connected to the controller at the CPC2 via a plug to exchange various information therebetween. The device 24 may be used to change values within the computer readable storage media, such as configurations settings, calibration variables, instructions for EGR, intake, and exhaust systems control and others. In operation, the controller 10 receives signals from various engine/vehicle sensors 26 and executes control logic embedded in hardware and/or software to control the engine 14. The computer readable storage media may, for example, include instructions stored thereon that are executable by the controller 10 to perform methods of controlling all features and sub-systems in the system 10. The program instructions may be executed by the controller in the MPU 12 to control the various systems and subsystems of the engine and/or vehicle through the input/output ports 15. Those skilled in the art recognize that other sensing and control communication between the controller and the various components are possible and contemplated within the scope of this discussion. Furthermore, it is appreciated that any number of sensors and features may be associated with each feature in the system for monitoring and controlling the operation thereof. The software used in the controller maybe developed in a software development station 19. The software may be a program 21 that is communicated to the controller, or it may include diagnostic configuration files and static textual data 23, that is memory storage intensive, that can be communicated from the remote software development station 19 directly to service tool 24 for communication to the controller.

In one non-limiting aspect of the present invention, the controller 10 may be the MCM/CPC2 controller, a.k.a. the DDEC controller available from Detroit Diesel Corporation, Detroit, Mich. Various other features of this controller are described in detail in a number U.S. patents assigned to Detroit Diesel Corporation. Further, the controller may include any of a number of programming and processing techniques or strategies to control any feature in the engine. More over, the present invention contemplates that the system may include more than one controller, such as separate controllers fro controlling system or sub-systems, including an exhaust system controller to control exhaust gas temperatures, mass flow rates, and other features associated therewith. In addition, these controllers may include other controllers besides the DDEC controller described above.

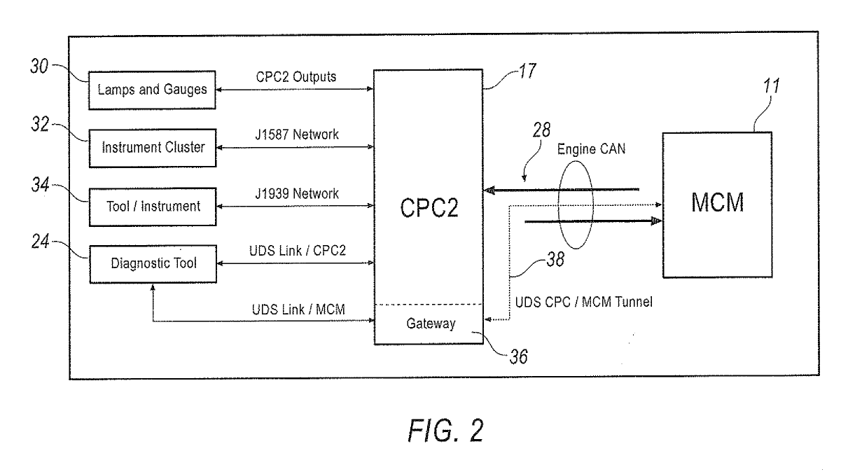

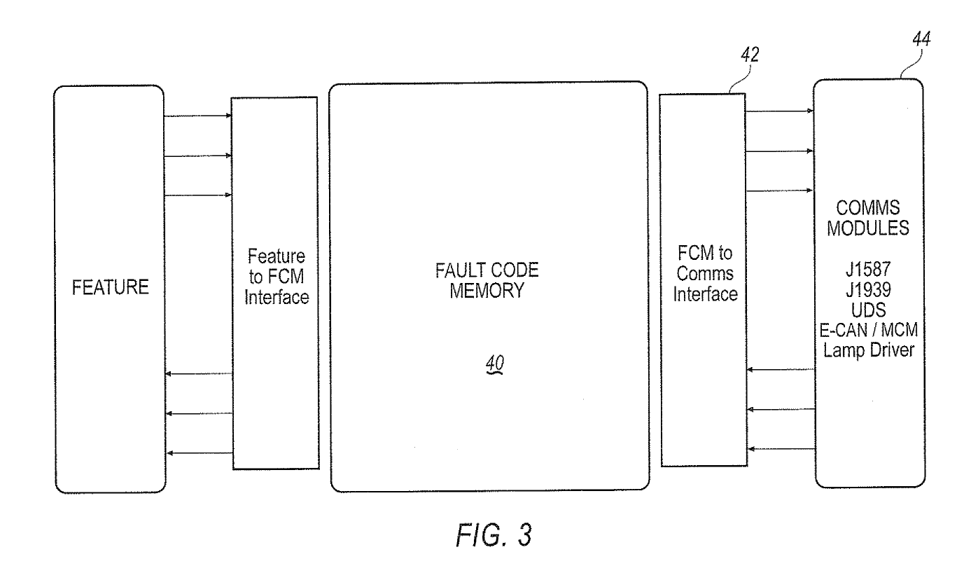

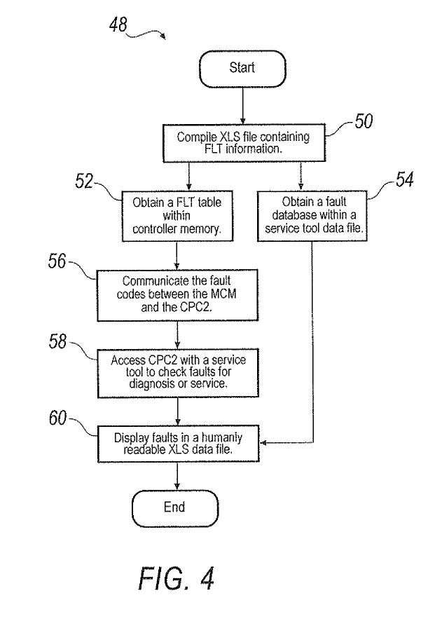

FIG. 2 is a schematic representation of the controller, showing interfaces between a Motor Control Module (MCM) 11 and a Common Powertrain Controller (CPC2) 17. The MCM and the CPC2 are in electronic communication with each other over an engine controller area network (ECAN) 28. The CPC2 receives and transmits fault information over SAE J1587/J1939 links, and more recently, it is contemplated to utilize UDS links (the new universal diagnostic system), wherein, for example, lamps and gauges 30, instrument cluster 32, tool and instruments 34 and diagnostic tools 24 all communicate with the CPC2. The CPC2 collects and translates the MCM faults via the ECAN from the MCM internal representation to the standardized IDs for J1587 and J1939 communication network. This permits the two boxes (MCM and CPC2) to appear as a single system for legacy J1587 and J1939 networks. Each controller may separately communicate with a diagnostic tool on the UDS link, however, it is contemplated that the CPC2 acts as a gateway 36 to the MCM on the J1587 and J1939 links when physical connections or request response message are transmitted or received by and through the CPC2. In order to facilitate the fast and efficient fault code memory gateway functionality, the CPC2 keeps a record of static MCM fault code data in xflash memory. This data is automatically updated if one of the controllers is reprogrammed or replaced on UDS CPC2/MCM tunnel 38.

The MCM may actuate CPC2 lamps and display faults on other links. In addition, the CPC2 has its own fault code memory logic and logs and processes its own faults which are also reported on the communication links and may affect the fault lamps. In addition to display and broadcast CPC2 and MCM faults, the CPC2 FCM (Fault Code Memory) module makes the fault information internally available to all features via a set of standard function-interfaces which allows the internal control to be altered depending on the presence of faults as seen in FIG. 3.

As seen in FIG. 3, the FCM module 40 interfaces at fault code MCM interface 42 to the individual features 44 which evaluate fault conditions and periodically provide the status or flags indicative of each individual fault condition in the FCM1. These fault condition status flags are then processed and debounced in the Fault Control Module internal logic based upon a configurable set of rules. The debounced faults are updated once per second via the ECAN. Once the faults are logged, they are kept and maintained in an internal list in fault code memory, which is then sent out on all communications links. Additional interfaces back to features 48 allow the system behavior to change, depending upon the active faults.

The static fault code data is stored in a unified table in memory in a humanly readable form when accessed by any service or diagnostic tool. One method 48 to autogenerate the static fault code data based upon a unified summary table for heavy duty diesel engine equipped with an electronic control as set forth above.

FIG. 4 is a software flowchart showing method 48 of the present invention. Step 50 is compiling vehicle fault codes in a table within memory of the controller. The table is in a humanly readable format. Step 52 is communicating the fault codes between the MCM and the CPC2. Step 54 is accessing the CPC2 with a service tool to check faults for diagnosis or service. The faults displayed on the service tool are in a humanly readable format.

The system is adapted to autogenerate static fault codes in humanly readable format based upon a unified summary table. Specifically, the controller comprised of the CPC2 and MCM contains a data table in memory with the faults listed in humanly readable format. While it is preferred that the data table be written in Excel format (xls.) any humanly readable format may be used. The Controller, usually through the CPC2, is accessed by an automated software tool or diagnostic took, and the data table accessed. The tool downloads executable fault code and configuration files to the CPC2 and MCM in response to the fault codes analyzed from the data xls. memory table. The data files (dat. file) regarding fault description and identification of faults are retained in memory on the tool for historical uses. In addition, these file are related to the engine software release version, and that information is uploaded to the tool. Thus, the tool has both the dat files related to the faults, and it has a record of the engine release software version from the engine controller accessed. The tool can be linked to a service PC, wherein the data files can be read as Excel (xls) files. The Service PC can receive fault ID from the MCM/CPC2 and perform diagnostics or reprogramming to correct the perceived problem.

In response to detection of faults, the system fault reaction is to limit engine torque or engine speed, or both, and to activate a warning indicator to alert an operator that a fault has been detected. Once serviced, or at the next ignition cycle, the system is reset.

The words used to describe the invention are words of description and to words of limitation. While one embodiment has been described, it is apparent to those of ordinary skill in the art that many modifications and variations are possible without departing from the scope and spirit of the invention as set forth in the appended claims.

What is claimed as new and desired to be protected by Letters Patent of the United States is:

1. A method for autogenerating static fault code data based upon a unified summary table for a heavy duty diesel engine equipped with an electronic control comprised of a Motor Control Module (MCM) and a Common Powertrain Controller (CPC2); each of said module and controller having a memory and in communication with each other, said method comprising:
compiling vehicle fault codes in a table within said memory; said table in a humanly readable format;
communicating said fault codes between said MCM and said CPC2; and
accessing said CPC2 with a service tool to check faults for diagnosis or service; said faults displayed on said service tool in a humanly readable format.

2. The method of claim 1, wherein said fault codes are stored in said MCM memory and communicated to said CPC2 for access by said service tool.

3. The method of claim 1, wherein said fault codes are stored as an Excel spreadsheet file within said memory.

4. 4. The method of claim 1, further including a remote software development station to create software and communicate it to the controller.

5. The method of claim 4, further including communicating diagnostic configuration files and static textual data to the service tool for communication to the controller.
